(19) United States
(12) Patent Application Publication
(10) Pub. No.: US 2024/0114359 A1
(43) Pub. Date: Apr. 4, 2024

(54) AI-ML MODEL STORAGE IN OTT SERVER AND TRANSFER THROUGH UP TRAFFIC

(71) Applicant: MEDIATEK INC., Hsinchu City (TW)

(72) Inventors: Ta-Yuan Liu, Hsinchu City (TW); Hao Bi, San Jose, CA (US); CHIA-CHUN HSU, Hsinchu City (TW)

(21) Appl. No.: 18/467,707

(22) Filed: Sep. 14, 2023

Related U.S. Application Data
(60) Provisional application No. 63/377,740, filed on Sep. 30, 2022.

(51) Int. Cl. H04W 24/02; H04L 41/16; H04W 36/08; H04W 76/10

(52) U.S. Cl. CPC H04W 24/02; H04L 41/16; H04W 36/08; H04W 76/10

(57) ABSTRACT

Apparatus and methods are provided for AI-ML model storage and transfer in the wireless network. In one novel aspect, the AI-ML model is stored at the AI server and transferred through the user plane (UP). In one embodiment, UE downloads the AI-ML model from the AI server through the UP connection. In one embodiment, the AI-ML model is updated at the RAN node, and the UE downloads the AI-ML model through the AI server. In another embodiment, the AI-ML model is updated at the UE, and the UE uploads the AI-ML model to the AI server through the UP connection. In another embodiment, the UE uploads the AI-ML model to the RAN through the AI server. In one embodiment, the UE mobility triggers the AI-ML model transfer. In one novel aspect, the AI dataset is shared and transferred among different entities through the UP connection or a new AI plane.

### CROSS REFERENCE TO RELATED APPLICATIONS

This application claims priority under 35 U.S.C. § 119 from U.S. Provisional Application No. 63/377,740 entitled “AI-ML MODEL STORAGE IN OTT SERVER AND TRANSFER THROUGH UP TRAFFIC,” filed on Sep. 30, 2022. The disclosure of each of the foregoing documents is incorporated herein by reference.

### TECHNICAL FIELD

The disclosed embodiments relate generally to wireless communication, and, more particularly, to AI-ML model storage and transfer.

### BACKGROUND

Artificial Intelligence (AI) and Machine Learning (ML) have permeated a wide spectrum of industries, ushering in substantial productivity enhancements. In the realm of mobile communications systems, these technologies are orchestrating transformative shifts. Mobile devices are progressively supplanting conventional algorithms with AI-ML models.

One key challenge in leveraging AI-ML models is their efficient storage and seamless deployment in real-world applications. Additionally, the proliferation of Over-The-Top (OTT) content delivery and the increasing demand for high-quality user experiences necessitate innovative solutions for data transfer in wireless networks. AI-ML models, being data-intensive and computation-heavy, require robust storage solutions and high-speed data transfers for effective deployment and execution.

Current solutions for AI-ML model storage and deployment involve cloud-based architectures, which can introduce latency due to network communication and may not be optimal for real-time applications. Furthermore, the soaring data traffic in wireless networks raises concerns about network congestion, latency, and overall quality of service. Addressing these challenges is crucial to unlocking the full potential of AI-ML applications in wireless environments.

Improvements and enhancements are required to enable and improve AI-ML model storage and transfer through the wireless network.

### SUMMARY

Apparatus and methods are provided for AI-ML model storage and transfer in the wireless network. In one novel aspect, the AI-ML model is transferred through the user plane (UP). In one embodiment, the UE sets up a UP connection for AI-ML model to an AI server through a RAN node in the wireless network. The UE transfers the AI-ML model with AI-ML model packets through the UP connection for the AI-ML model. In one embodiment, the AI-ML model is trained and stored at the AI server and the UE downloads the AI-ML model from the AI server through the UP connection. In one embodiment, the AI-ML model is either invisible or partially invisible to the RAN/CN. In another embodiment, the RAN/CN node parses the AI-ML model. In one embodiment, the AI-ML model is trained or updated/fine-tuned at the RAN node, and the UE downloads the AI-ML model through the AI server. In another embodiment, the AI-ML model is trained and/or fine-tuned at the UE, and the UE uploads the AI-ML model to the AI server through the UP connection. In another embodiment, the UE uploads the AI-ML model to the RAN through the AI server.

In one embodiment, the UE mobility triggers the AI-ML model transfer. In one embodiment, the UE uploads or downloads the AI-ML model upon successful handover through the UP connection. In one embodiment, the source RAN transfers the AI-ML model to the target RAN. The target RAN transfers the updated AI-ML model to the UE upon success of the handover. In another embodiment, the RAN node informs the AI server of the success of the handover and requested the AI server to transfer the AI-ML model to the UE.

In one novel aspect, the AI dataset is shared and transferred among different entities including the UE, the RAN/CN, and the AI server in the wireless network. In one embodiment, the UP connection is used for the transferring of the AI dataset. In another embodiment, a new AI plane is used for the AI dataset transfer.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network that supports AI-ML model storage and transfer with OTT server through user plane in accordance with embodiments of the current invention.

FIG. 2 illustrates an exemplary top-level diagram for the AI-ML model download from the AI server in accordance with embodiments of the current invention.

FIG. 3 illustrates an exemplary top-level diagram for the AI-ML model download from the RAN node through AI server in accordance with embodiments of the current invention.

FIG. 4 illustrates an exemplary flow diagram for the AI-ML model download from the AI server to the UE through the UP traffic where the model is invisible or partly visible to the RAN/CN node in accordance with embodiments of the current invention.

FIG. 5 illustrates an exemplary flow diagram for the AI-ML model download from the AI server to the UE through the UP traffic where the model is parsed at the RAN/CN node in accordance with embodiments of the current invention.

FIG. 6 illustrates an exemplary flow diagram for the AI-ML model download from the AI server where the RAN/CN node stores the model in accordance with embodiments of the current invention.

FIG. 7 illustrates an exemplary flow diagram for the AI-ML model download from RAN/CN through the AI server in accordance with embodiments of the current invention.

FIG. 8 illustrates top-level diagrams for the UE upload the AI-ML model to the AI server through UP traffic in accordance with embodiments of the current invention.

FIG. 9 illustrates top-level diagrams for the UE upload the AI-ML model to RAN/CN node through the AI server through UP traffic in accordance with embodiments of the current invention.

FIG. 10 illustrates a flow diagram for the UE upload the AI-ML model through UP traffic in accordance with embodiments of the current invention.

FIG. 11 illustrates exemplary top-level diagrams for UE mobility triggered AI-ML model transfer and AI-ML model transfer triggers in accordance with embodiments of the current invention.

FIG. 12 illustrates an exemplary flow diagram for UE mobility triggered AI-ML model transfer from the source RAN/CN to the target RAN/CN in accordance with embodiments of the current invention.

FIG. 13 illustrates an exemplary flow diagram for UE mobility triggered AI-ML model transfer through the AI server in accordance with embodiments of the current invention.

FIG. 14 illustrates exemplary diagrams AI-ML model format and description for the AI-ML model transfer through the UP connection in accordance with embodiments of the current invention.

FIG. 15 illustrates exemplary diagrams for AI dataset transfer through an AI plane or the UP plane in accordance with embodiments of the current invention.

FIG. 16 illustrates an exemplary flow chart for the UE to perform the AI-ML model transfer through the UP connection in accordance with embodiments of the current invention.

FIG. 17 illustrates an exemplary flow chart for the UE to perform the AI dataset transfer through an AI plane or the UP connection in accordance with embodiments of the current invention.

FIG. 18 illustrates an exemplary flow chart for the RAN node to perform the AI-ML model transfer through the UP connection in accordance with embodiments of the current invention.

### DETAILED DESCRIPTION

Reference will now be made in detail to some embodiments of the invention, examples of which are illustrated in the accompanying drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (Collectively referred to as “elements”). These elements may be implemented using electronic hardware, computer software, or any combination thereof. Whether such elements are implemented as hardware or software depends upon the particular application and design constraints imposed on the overall system. Please also note that terms such as transfer means uplink transfer and/or downlink transfer.

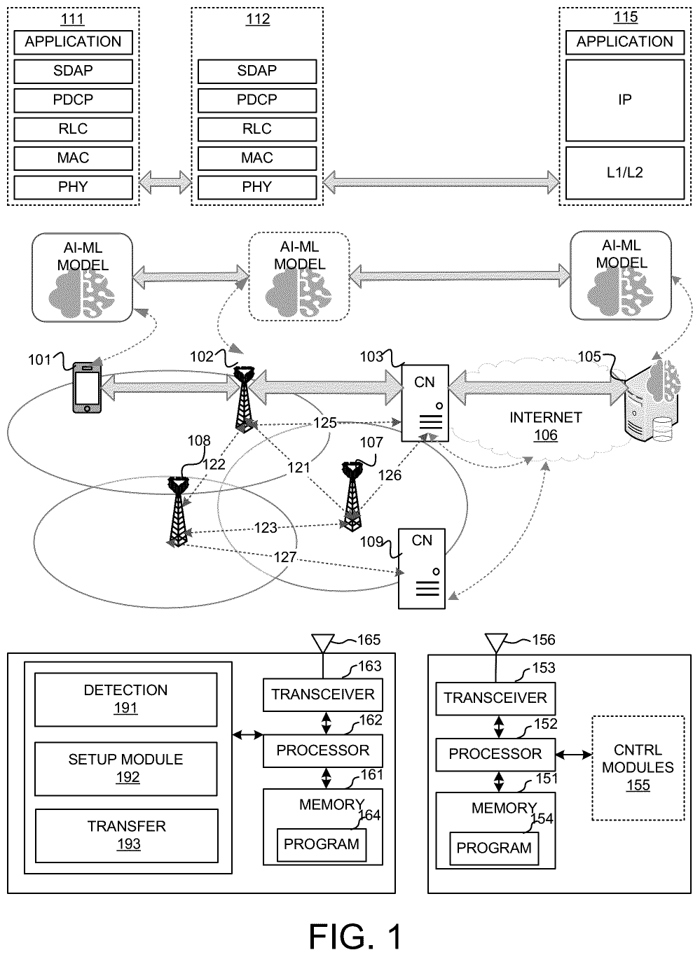

FIG. 1 is a schematic system diagram illustrating an exemplary wireless network that supports AI-ML model storage and transfer with OTT server through user plane in accordance with embodiments of the current invention. AI-ML model can improve performances for mobile devices with application in the areas such as mobility management, sensing and localization, smart signaling and interference management. The infusion of AI-ML models into mobile devices has paved the way for an array of novel applications, such as, enriched photography, intelligent personal assistants, Virtual Reality (VR) and Augmented Reality (AR) experiences, immersive video gaming, and sophisticated video analytics. Moreover, these models underpin personalized shopping recommendations, autonomous driving/navigation systems, seamlessly integrated smart home appliances, mobile robotics, cutting-edge mobile medical solutions, and innovative mobile finance platforms.

Wireless communication network 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. As an example, base stations serve a number of mobile stations within a serving area, for example, a cell, or within a cell sector. In some systems, one or more base stations are coupled to a controller forming an access network that is coupled to one or more core networks. gNB 102, gNB 107 and gNB 108 are base stations in the wireless network, the serving area of which may or may not overlap with each other. gNB 102 is connected with gNB 107 via Xn interface 121. gNB 102 is connected with gNB 108 via Xn interface 122. gNB 107 is connected with gNB 108 via Xn interface 123. Core network (CN) entity 103 connects with gNB 102 and 107, through NG interface 125 and 126, respectively. Network entity CN 109 connects with gNB 108 via NG connection 127. Exemplary CN 103 and CN 109 connect to AI server 105 through internet 106. CN 103 and 109 includes core components such as user plane function (UPF) and core access and mobility management function (AMF).

In one novel aspect, AI server 105 stores AI-ML model and transfers the AI-ML model to and from the UEs, such as UE 101 through user plane (UP) data traffic. As illustrated, UE 101 has protocol stack 111 including PHY, medium access control (MAC), radio link control (RLC), packet data convergence protocol (PDCP), service data adaptation protocol (SDAP) and application layer. UE establishes UP connection through a radio access network (RAN) node, such as gNB 102, which has a protocol stack 112 including PHY, MAC, RLC, PDCP and SDAP. UE 101 establishes UP connection with AI server 105 through gNB 102 and CN 103, which connects with AI server 105 through the Internet. AI server 105 has a protocol stack including L1/L2, IP and application layer. The AI-ML model transfer can happen in either one-side or two-side AI-ML model procedure. In one scenario, AI-ML model is needed at either UE side or the network side alone. The one-side AI-ML model transfer procedure is needed. In another scenario, AI-ML model is needed at both the UE side and the network sides. The two-side AI-ML model transfer procedure is needed. In one embodiment, as UE moves around, UE mobility triggers AI-ML model transfer. For example, when UE 101 moves from cells served by gNB 102 to cells served by gNB 107, AI-ML model transfer is triggered. The AI-ML model transfer may be triggered by intra CN mobility, such as UE moves from gNB 102 to gNB 107. The AI-ML model transfer may be triggered by inter CN mobility, such as UE moves from gNB 102 connecting with CN 103 to gNB 108 that is connected to CN 109.

In one embodiment, AI server 105 is an over-the-top (OTT) server. In one scenario, the AI-ML model is stored in network-vendor OTT servers or UE-vendor OTT servers. The UP traffic between the OTT server and the UE is configured with specific QoS and latency requirement, which is designed for the large-size AI-ML model transfer and for applying AI to wireless communication. Further, the network node, such as RAN node 102, can be configured such that the AI-ML model is transparent. The UP traffic transfer addresses different proprietary requirements for the AI-ML model transfer.

FIG. 1 further illustrates simplified block diagrams of a base station and a mobile device/UE that supports AI-ML model storage and transferring through UP traffic. gNB 102 has an antenna 156, which transmits and receives radio signals. An RF transceiver circuit 153, coupled with the antenna 156, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 106. Memory 151 stores program instructions and data 154 to control the operations of gNB 102. gNB 102 also includes a set of control modules 155 that carry out functional tasks to communicate with mobile stations. These control modules can be implemented by circuits, software, firmware, or a combination of them.

FIG. 1 also includes simplified block diagrams of a UE, such as UE 101. The UE has an antenna 165, which transmits and receives radio signals. An RF transceiver circuit 163, coupled with the antenna, receives RF signals from antenna 165, converts them to baseband signals, and sends them to processor 162. RF transceiver 163 also converts received baseband signals from processor 162, converts them to RF signals, and sends out to antenna 165. Processor 162 processes the received baseband signals and invokes different functional modules to perform features in UE 101. Memory 161 stores program instructions and data 164 to control the operations of UE 101. Antenna 165 sends uplink transmission and receives downlink transmissions to/from antenna 156 of gNB 102.

The UE also includes a set of control modules that carry out functional tasks. These control modules can be implemented by circuits, software, firmware, or a combination of them. Detection module 191 detects one or more preconfigured trigger events for transferring an AI-ML model. Setup module 192 sets up a user plane (UP) connection for AI between the UE and an AI server through a radio access network (RAN) node and a CN node in the wireless network. Transfer module 193 transfers the AI-ML model with AI-ML model packets through the UP connection for AI in the wireless network. The UE transfers the AI-ML model from the AI server using the downlink of the UP connection for AI when the AI-ML model is updated at the AI server and/or at the RAN node. The UE transfers the AI-ML model to the AI server using uplink of the UP connection for AI. In one embodiment, the UE also transfers the AI-ML model the RAN node through the AI server, wherein the UE transfers the AI-ML model to the AI server and the AI server transfers the UE-updated AI-ML model to the RAN node.

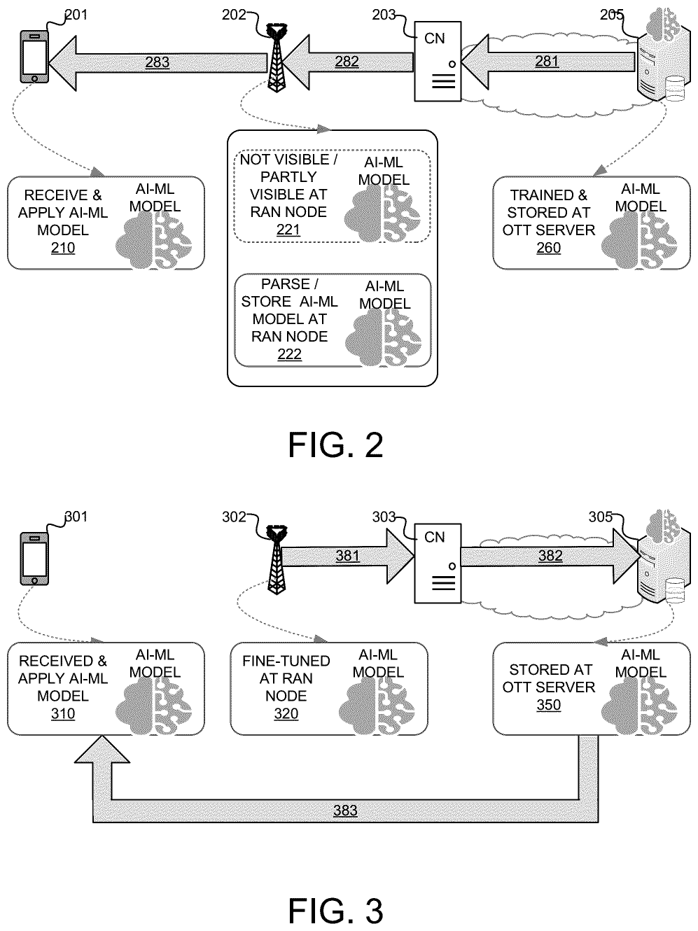

FIG. 2 illustrates an exemplary top-level diagram for the AI-ML model download from the AI server in accordance with embodiments of the current invention. UE 201 establishes UP connection with AI server 205 in the wireless network through RAN node 202 and CN 203. In one embodiment, AI server 205 is an OTT server. In one scenario, the AI-ML model is not directly visible to the RAN node 202 during the download procedure. In another scenario, the RAN node 202 parses the AI-ML model through the UP traffic. In one embodiment, during the AI-ML model download from the AI server, the RAN node is configured based on the proprietary setting of the AI-ML model.

There are different scenarios. In the first scenario, RAN node 202 and/or CN node 203 are not aware of the model transfer. UE 101 directly sends the model transfer request through UP traffic to OTT server 205 to download the AI-ML model. In the second scenario, RAN node 202 and/or CN node 203 do not know the information of the AI-ML model but are aware of the AI-ML model transfer. The AI-ML model proprietary information is not exposed to the RAN/CN node. In the third scenario, RAN node 202 and/or CN node 203 does not know the exact information of the AI-ML model but knows AI-related information, such as application scenarios, supported features. In the fourth scenario, RAN node 202 and/or CN node 203 are aware of the AI-ML model transfer and directly parses the model during the model transfer. In the fifth scenario, the AI-ML model is first transferred from the AI server to RAN node 202 and/or CN node 203. The model is saved at the RAN/CN node and UE 201 downloads the AI-ML model from the RAN node. As illustrated, at step 281, the stored AI-ML model 260 is transferred through UP traffic to CN 203. At step 282, CN 203 transfers the AI-ML model to RAN node 202. At step 283, RAN node 202 transfers the model to UE 201. As in the first, second and third scenario, AI-ML model 221 is not visible to the CN/RAN nodes. In some scenarios, AI-ML model 221 is partly visible to the RAN/CN, such as the AI-related information. UE receives AI-ML model 210 through the UP traffic and applies the AI-ML model.

FIG. 3 illustrates an exemplary top-level diagram for the AI-ML model download from the RAN node through AI server in accordance with embodiments of the current invention. UE 301 establishes UP connection with AI server 305 in the wireless network through RAN node 302 and CN 303. In one embodiment, AI server 305 is an OTT server. In one scenario, AI-ML model 320 is fined-tuned at RAN node 302. In another scenario, AI-ML model 320 is trained at RAN node 302. A model transfer is triggered by the availability of a new or updated AI-ML model 320 at RAN node 302. In one embodiment, the AI-ML model is first uploaded to the AI server 305, at steps 381 and 382. AI server 305 stores the uploaded AI-ML model (350). At step 383, AI server 305 transfers the AI-ML model to UE 305. UE 301 receives and applies the AI-ML model (310).

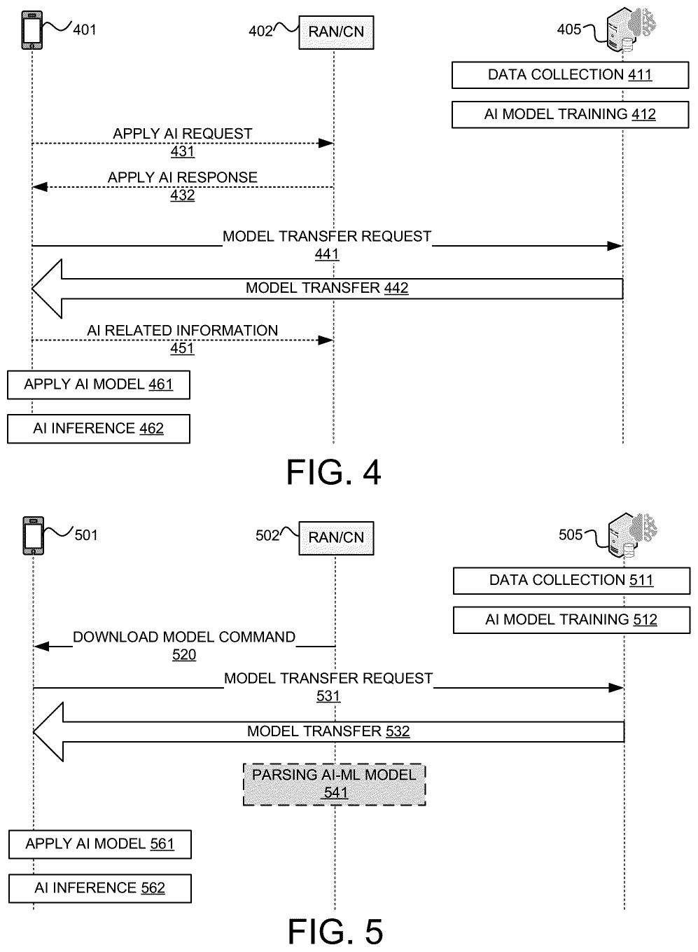

FIG. 4 illustrates an exemplary flow diagram for the AI-ML model download from the AI server to the UE through the UP traffic where the model is invisible or partly visible to the RAN/CN node in accordance with embodiments of the current invention. UE 401 establishes UP connection with AI server 405 through RAN (RAN/CN) node 402. In one embodiment, AI server 405 is an OTT server. UE 401 downloads the model from the OTT server. At step 411, AI server 405 performs data collection for the AI-ML model. At step 412, AI server 405 performs AI model training. AI-ML model is stored at AI server 405. In one scenario, the RAN node 402 is not aware of the model transfer. The AI-ML model is invisible or partly visible to RAN node 402. For fully proprietary case, at step 441, UE 401 directly sends model transfer request to AI server 405.

In another scenario, the RAN/CN is configured to monitor the AI-ML model transfer performance and control the AI-ML model transfer procedure. In this scenario, at step 431, UE informs RAN/CN 402 with apply AI request, informing the RAN/CN node about the availability of the AI-ML model and AI-related information. At step 432, RAN/CN 402 sends UE 401 apply AI response. UE 401, at step 441, sends model transfer request directly to AI server 405. At step 442, UE 401 receives model transfer from AI server 405. Optionally, at step 451, UE 401 sends RAN/CN 402 AI-related information. At step 461, UE 401 applies AI model. At step 462, UE performs AI inference based on the updated AI model for target tasks. In one embodiment, UE applies the received AI-ML model on the modem to enhance wireless communication performances. In one embodiment, the AI-ML model transfer is triggered by an update of the AI-ML model.

FIG. 5 illustrates an exemplary flow diagram for the AI-ML model download from the AI server to the UE through the UP traffic where the model is parsed at the RAN/CN node in accordance with embodiments of the current invention. UE 501 establishes UP connection with AI server 505 through RAN (RAN/CN) node 502. In one embodiment, AI server 505 is an OTT server. UE 501 downloads the model from the OTT server. At step 511, AI server 505 performs data collection for the AI-ML model. At step 512, AI server 505 performs AI model training. AI-ML model is stored at AI server 505. In one scenario, RAN/CN node 502 needs to know the information of the AI-ML model, such as for the two-side AI-ML procedure. At step 520, RAN/CN 502 sends download model command to UE 501. At step 531, UE 501 sends model transfer request to AI server 505. At step 532, AI server 505 starts model transfer through RAN/CN 502 using the UP connection. At step 541, RAN/CN 502 directly parses the AI-ML model during the model transfer and sends the AI-ML model to UE 501. At step 561, UE 501 applies AI model. At step 562, UE performs AI inference.

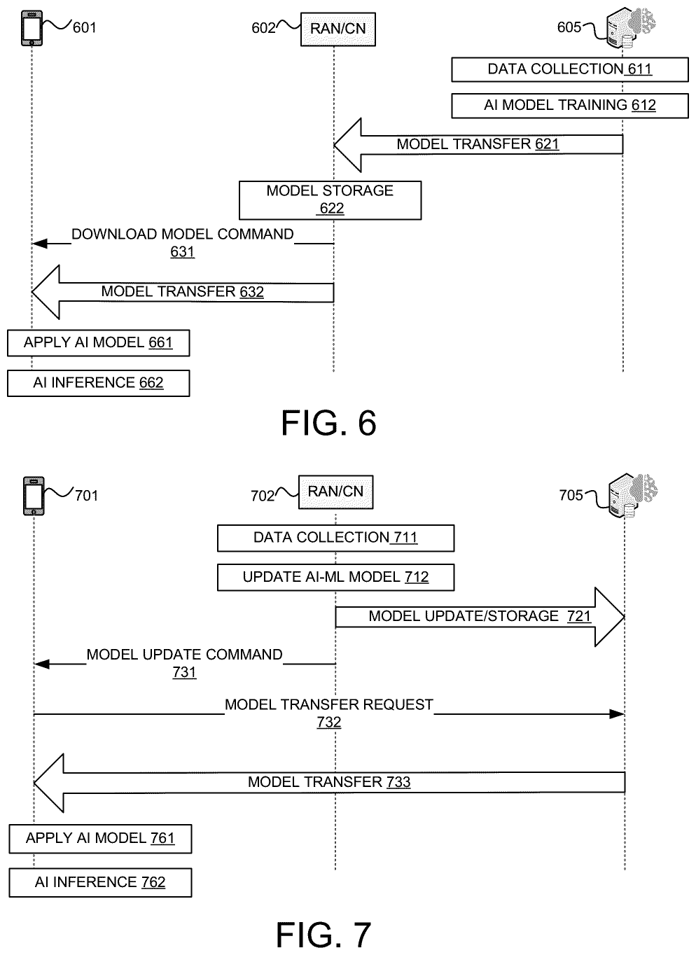

FIG. 6 illustrates an exemplary flow diagram for the AI-ML model download from the AI server where the RAN/CN node stores the model in accordance with embodiments of the current invention. UE 601 establishes UP connection with AI server 605 through RAN (RAN/CN) node 602. In one embodiment, AI server 605 is an OTT server. UE 601 downloads the model from the OTT server. At step 611, AI server 605 performs data collection for the AI-ML model. At step 612, AI server 605 performs AI model training. AI-ML model is stored at AI server 605. In one embodiment, the AI server delivers the AI-ML model for UE 601 to RAN/CN 602. At step 621, AI server 605 performs model transfer to RAN/CN 602 through UP connection. At step 622, RAN/CN 602 stores the received AI-ML model. At step 631, RAN/CN 602 sends download model command to UE 601. At step 632, the model is transferred from RAN/CN 602 to UE 601 through the UP connection. At step 661, UE 601 applies AI model. At step 662, UE 601 perform AI inference.

FIG. 7 illustrates an exemplary flow diagram for the AI-ML model download from RAN/CN through the AI server in accordance with embodiments of the current invention. In one embodiment, the UE download the AI-ML model at the RAN/CN node through the AI server. UE 701 establishes UP connection with AI server 705 through RAN (RAN/CN) node 702. In one embodiment, AI server 705 is an OTT server. At step 711, RAN/CN 702 performs data collection for the AI-ML model. At step 712, RAN/CN 702 update AI-ML model by AI training or AI fine-tuning. In one embodiment, RAN/CN 702 stores AI-ML model. In one embodiment, the model transfer is triggered by the availability of a new AI model for the UE at the RAN/CN 702. For example, the AI-ML model is fine-tuned on the RAN/CN 702 when new data is available. RAN/CN 702 first updates the AI-ML model. In one embodiment, at step 721, RAN/CN 702 uploads the updated AI-ML model to AI server 705. The new AI-ML model is saved on AI server 705. RAN/CN 702 notifies UE 701, at step 731, by sending model update command. At step 732, UE 701 sends model transfer request to AI server 705. At step 733, AI server 705 transfers the updated/new AI-ML model to UE 701 through the UP connection. At step 761, UE 701 applies AI model. At step 762, UE 701 perform AI inference.

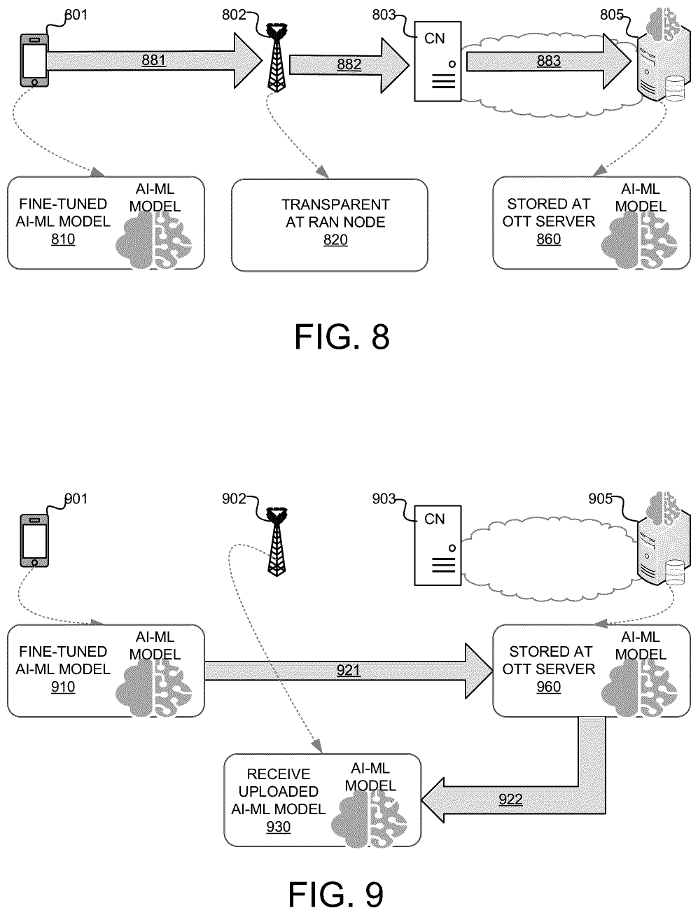

FIG. 8 illustrates top-level diagrams for the UE upload the AI-ML model to the AI server through UP traffic in accordance with embodiments of the current invention. UE 801 establishes UP connection with AI server 805 through RAN node 802 and CN node 803. In one embodiment, AI server 805 is an OTT server. In one embodiment, UE 801 performs data collection and trains AI-ML model 810. In another embodiment, UE 801 fine tunes AI-ML model 810. At step 881, UE 801 transfers AI-ML model to RAN node 802, which transfers to CN node 803 at step 882. In one embodiment 820, the uploaded AI-ML model is transparent at RAN node 802 and/or CN 803. At step 882, RAN node 802 transfers AI-ML model to CN 803 through UP connection. At step 883, CN 803 transfers the AI-ML model to AI server 805. AI server 805 stores the uploaded AI-ML model (860).

FIG. 9 illustrates top-level diagrams for the UE upload the AI-ML model to RAN/CN node through the AI server through UP traffic in accordance with embodiments of the current invention. UE 901 establishes UP connection with AI server 905 through RAN node 902 and CN node 903. In one embodiment, AI server 905 is an OTT server. In one embodiment, UE 901 performs data collection and trains AI-ML model 910. In another embodiment, UE 901 fine tunes AI-ML model 910. In one embodiment, UE 901 uploads the new or updated AI-ML model 910 to RAN 902 and/or CN 903 through AI server 905. At step 921, UE uploads the AI-ML model to AI server 905. AI server 905 stores the received AI-ML model (960). At step 922, AI server 905 transfers the received AI-ML model to RAN 902 and/or CN 903 (930).

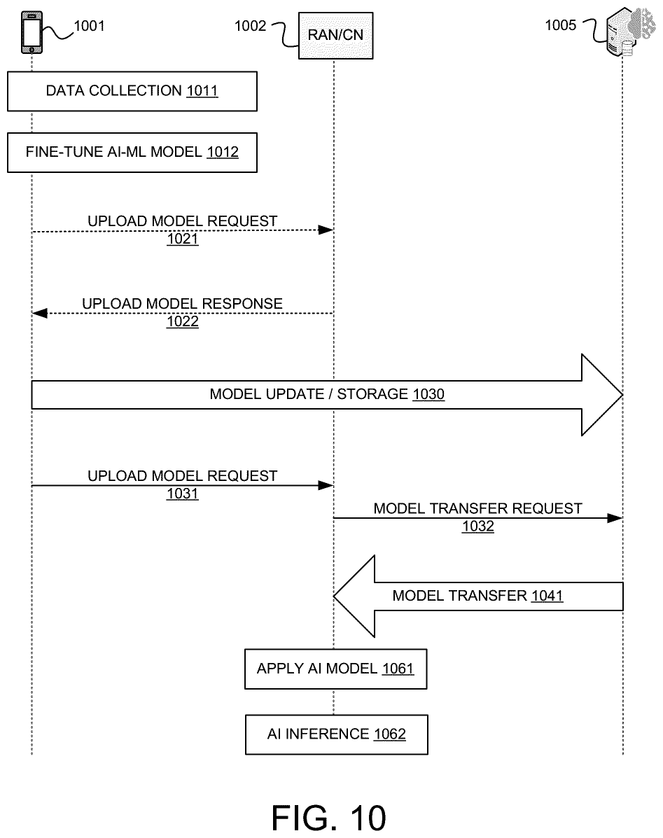

FIG. 10 illustrates a flow diagram for the UE upload the AI-ML model through UP traffic in accordance with embodiments of the current invention. UE 1001 establishes UP connection with AI server 1005 through RAN (RAN/CN) node 1002. In one embodiment, AI server 1005 is an OTT server. In one embodiment, UE 1001 performs data collection (1011). At step 1012, UE 1001 fine tunes the AI-ML model. In one embodiment, the upload AI-ML model is triggered by the new AI model generated by the UE. For example, the AI-ML model is fine-tuned on the UE if new data is available. At step 1021, the UE sends upload model request to RAN/CN 1002. At step 1022, RAN/CN 1002 sends upload model response to UE 1001. After receiving the upload model response, at step 1030, UE 1001 starts model update/uploading to AI server 1005 through the UP connection. In one embodiment, if AI server/OTT server 1005 belongs to the UE vendor, UE 1001 skips steps 1021 and 1022 and directly upload the AI-ML model to AI server 1005. After uploading the model to AI server 1005, UE 1001, at step 1031 sends upload model request to RAN/CN 1002, requesting the RAN/CN 1002 to obtain the updated AI-ML model from the AI server. At step 1032, upon receiving the UE request, RAN/CN 1002 sends model transfer request to AI server 1005. At step 1041, AI server 1051 transfers AI-ML model to RAN/CN 1002. At step 1061 RAN/CN 1002 applies AI model. At step 1062, RAN/CN 1002 perform AI inference.

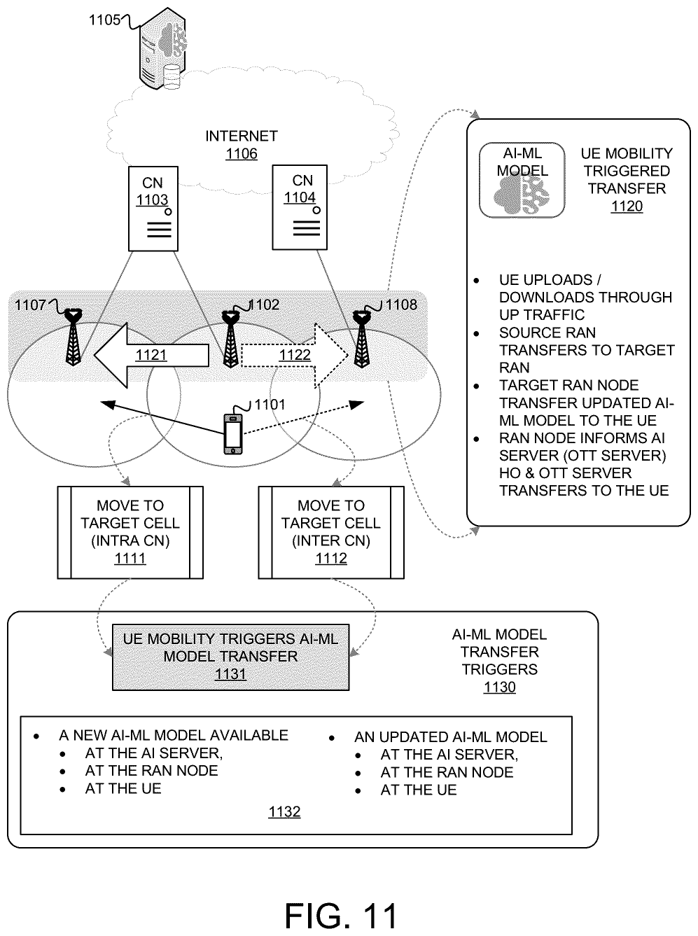

FIG. 11 illustrates exemplary top-level diagrams for UE mobility triggered AI-ML model transfer and AI-ML model transfer triggers in accordance with embodiments of the current invention. In one embodiment 1120, AI-ML model is updated and transferred due to UE mobility. As an example, UE 1101 establishes UP connection with AI server 1105 through source RAN 1102, which is connected to CN 1103. As UE 1101 moves around, UE 1101 may switch over to target RAN 1107, which is connected to CN 1103. UE 1101 may also switch over to target RAN 1108, which is connected to CN 1104. CN 1103 and CN 1104 connect with AI server 1105 through internet 1106. In another scenario, not shown, CN 1104 may connect to a different AI server, which communicates with AI 1105. As UE 1101 performs intra CN handover 1111, from RAN 1102 to RAN 1107 and/or inter CN handover 1112, from RAN 1102 to RAN 1108, the UE mobility triggers AI-ML model update/transfer. In one embodiment, AI-ML model transfer triggers 1130 includes UE mobility triggered AI-ML model transfer 1131 and/or other triggers 1132 including new AI-ML model availability at the AI server, the RAN node, and/or the UE; and/or AI-ML model update at the AI server, the RAN node, and/or the UE.

The UE mobility triggered AI-ML model transfer (1120) enable the UE to get updated AI-ML model during UE mobility. In one embodiment, the UE uploads and/or downloads the AI-ML model after switching to the target RAN through established UP connections. In one embodiment, the source RAN transfers the AI-ML model to the target RAN. In another embodiment, the target RAN transfers the received AI-ML model to the UE. In another embodiment, the RAN node informs the AI server the handover and the AI server transfers the AI-ML model to the UE.

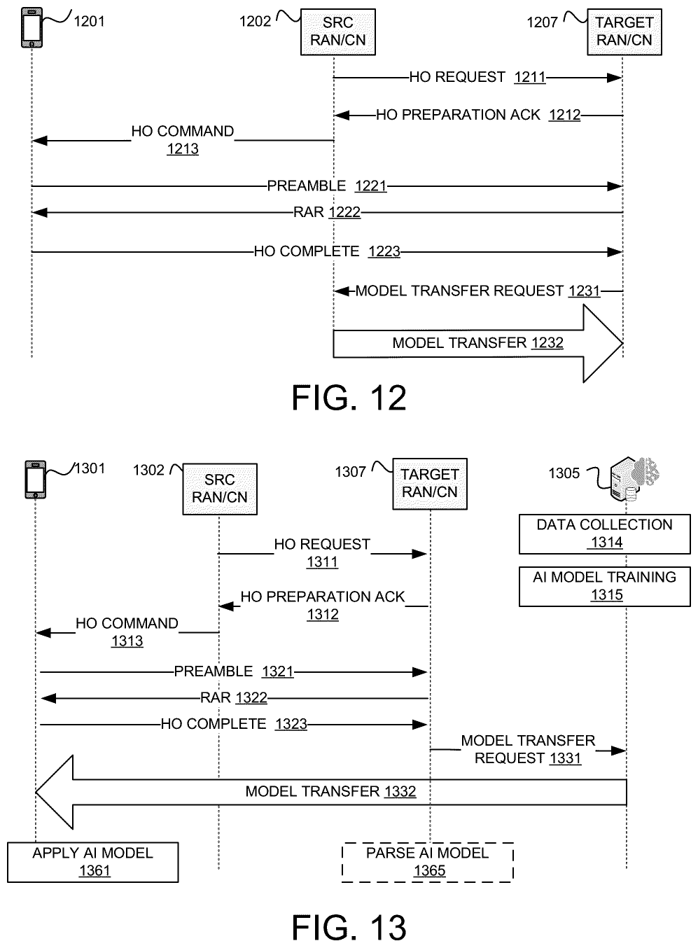

FIG. 12 illustrates an exemplary flow diagram for UE mobility triggered AI-ML model transfer from the source RAN/CN to the target RAN/CN in accordance with embodiments of the current invention. UE 1201 establishes UP connection with source RAN 1202. As UE 1201 moves around, handover procedure is triggered from source RAN 1202 to target RAN 1207. At step 1211, source RAN 1202 sends handover (HO) request to target RAN 1207. At step 1212, target RAN 1207 sends HO preparation ACK to source RAN 1202. At step 1213, source RAN 1202 sends HO command to UE 1201. In one embodiment, UE 1201 starts random access procedure to target RAN 1207. At step 1221, UE 1201 sends preamble to target RAN 1207. At step 1222, target RAN 1207 sends random access response (RAR) to UE 1201. At step 1223, UE 1201 sends HO complete to target RAN 1207. When the handover is successful, at step 1231, target RAN 1207 sends model transfer request to source RAN 1202. At step 1232, source RAN 1202 sends AI-ML model to target RAN 1027. The flow diagram is an exemplary flow chart. The handover procedure may be performed in other ways. In one novel aspect, the AI model is available for the UE after the handover procedure. In one embodiment, the AI-ML model is transferred from the source RAN to the target RAN. Upon the success of the handover procedure, the target RAN send model update request to the source RAN. The AI-ML model is transferred from the source RAN to the target RAN.

FIG. 13 illustrates an exemplary flow diagram for UE mobility triggered AI-ML model transfer through the AI server in accordance with embodiments of the current invention. UE 1301 establishes UP connection with AI server 1305 through source RAN 1302. As UE 1301 moves around, handover procedure is triggered from source RAN 1302 to target RAN 1307. At step 1311, source RAN 1302 sends HO request to target RAN 1307. At step 1312, target RAN 1307 sends HO preparation ACK to source RAN 1302. At step 1313, source RAN 1302 sends HO command to UE 1301. In one embodiment, UE 1301 starts random access procedure to target RAN 1307. At step 1321, UE 1301 sends preamble to target RAN 1307. At step 1322, target RAN 1307 sends RAR to UE 1301. At step 1323, UE 1301 sends HO complete to target RAN 1307. When the handover is successful, at step 1331, target RAN 1307 sends model transfer request to AI server 1305. At step 1332, AI server 1305 transfers AI-ML model to UE 1301. At step 1361, UE 1301 applies the AI-ML model. In one embodiment, similar to the AI-ML model download, target RAN 1307, at step 1365, parses the AI-ML model during the AI-ML model download to UE 1301. Similar to the AI-ML model download, the AI-ML model transfer at step 1332 may be invisible to target RAN 1307, or partially visible, with the AI-related information for the target RAN.

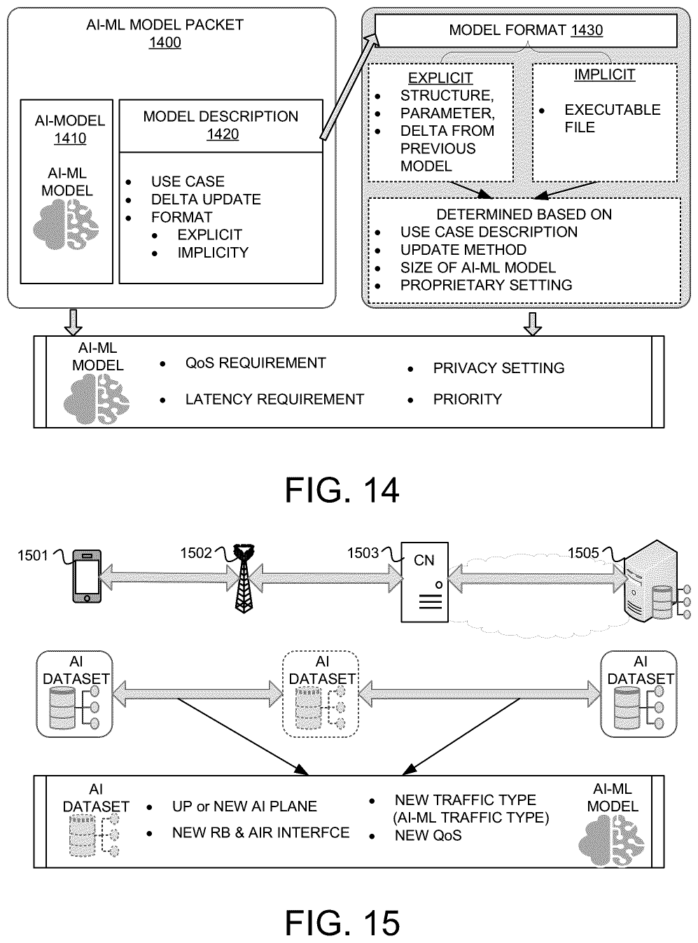

FIG. 14 illustrates exemplary diagrams of AI-ML model format and description, for the AI-ML model transfer through the UP connection in accordance with embodiments of the current invention. In one embodiment, AI-ML model packet 1400 includes AI-ML model/data 1410 and model description 1420. The AI-ML model may be transferred in different formats (1430). The AI-ML format is determined based on one or more factors including the use case description, the update method, the size of AI-ML model and the proprietary settings for the AI-ML model. Model description 1420 includes one or more elements including the use case description, an indication of whether it is a delta update, and the model format information. Model description 1420 helps the receiving entity to interpret the model format. AI-ML model format 1430 includes explicit format and implicit format. The explicit format is predefined, such as defined by 3GPP or other standard platforms or through agreements. The explicit format includes one or more elements including the structure, the parameters, the delta information from the previous model. The implicit format includes runtime image format/executable files. In one embodiment, the AI-ML model is transferred through the UP connection as a new AI-ML model traffic type with one or more traffic elements including AI QoS definition, latency requirement, model privacy setting, and priority setting.

FIG. 15 illustrates exemplary diagrams for AI dataset transfer through an AI plane or the UP plane in accordance with embodiments of the current invention. In one novel aspect, AI dataset is transferred in the wireless network through UP connection or a new AI plane. In one embodiment, the AI dataset and the AI-ML model are transferred through the UP connection. In another embodiment, the AI dataset and/or the AI-ML model are transferred through a new defined AI plane. In one embodiment, UE 1501 established UP connection with AI server 1505 through RAN 1502 and CN 1503. In one embodiment, AI server 1505 is an OTT server. In some scenarios, the dataset is shared among different entities for AI-ML use cases, such as joint training and/or separated training procedures. In one embodiment, AI dataset is shared between different entities, includes UE 1501, RAN 1502 (or CN 1503), and AI server 1505. In some scenarios, the dataset is of very large size. In one embodiment, a new AI plane is created for the dataset sharing/transferring. In one embodiment, a new resource block (RB) is defined for the dataset sharing. In yet another embodiment, new traffic including QoS is defined for the AI dataset/AI-ML model. The new AI traffic type, AI RB, and/or the AI air interface are defined to the meet the AI dataset (and/or AI-ML model) requirements including large data size, latency requirement, privacy setting, one-side or two-side application setting and priority setting.

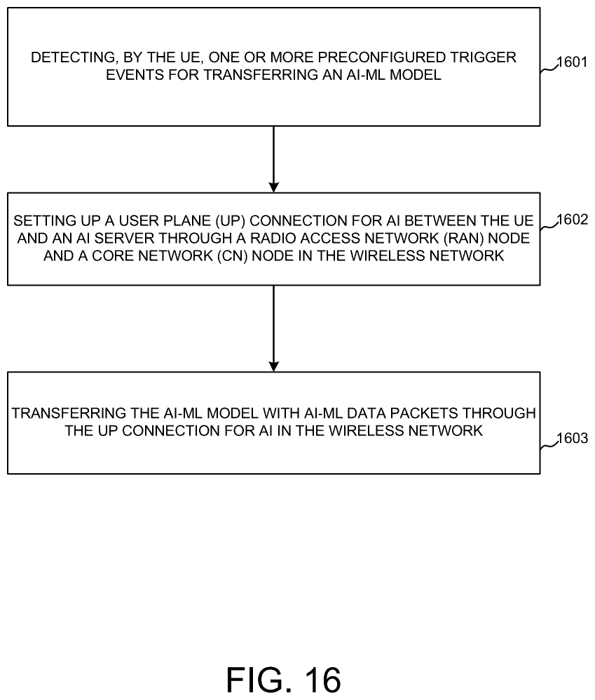

FIG. 16 illustrates an exemplary flow chart for the UE to perform the AI-ML model transfer through the UP connection in accordance with embodiments of the current invention. At step 1601, the UE detects one or more preconfigured trigger events for transferring an AI-ML model. At step 1602 the UE sets up a user plane (UP) connection for AI between the UE and an AI server through a radio access network (RAN) node and a core network (CN) node in the wireless network. At step 1603, the UE transfers the AI-ML model with AI-ML model packets through the UP connection for AI in the wireless network.

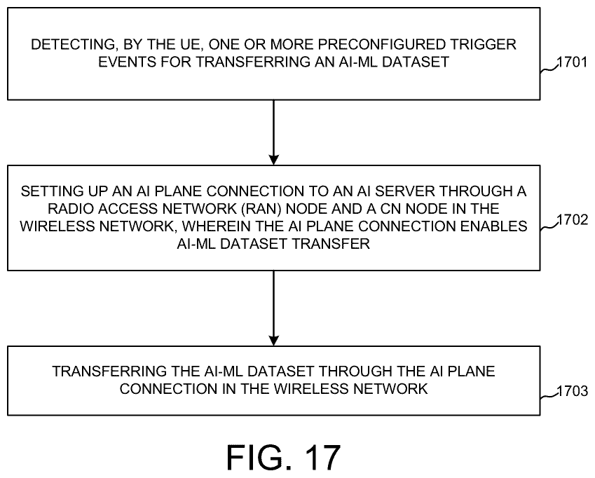

FIG. 17 illustrates an exemplary flow chart for the UE to perform the AI dataset transfer through an AI plane or the UP connection in accordance with embodiments of the current invention. At step 1701, the UE detects one or more preconfigured trigger events for transferring an AI-ML dataset. At step 1702, the UE sets up an AI plane connection to an AI server through a radio access network (RAN) node and a core network (CN) node in the wireless network, wherein the AI plane connection enables transfer of AI-ML dataset. At step 1703, the UE transfers the AI-ML dataset through the AI plane connection in the wireless network.

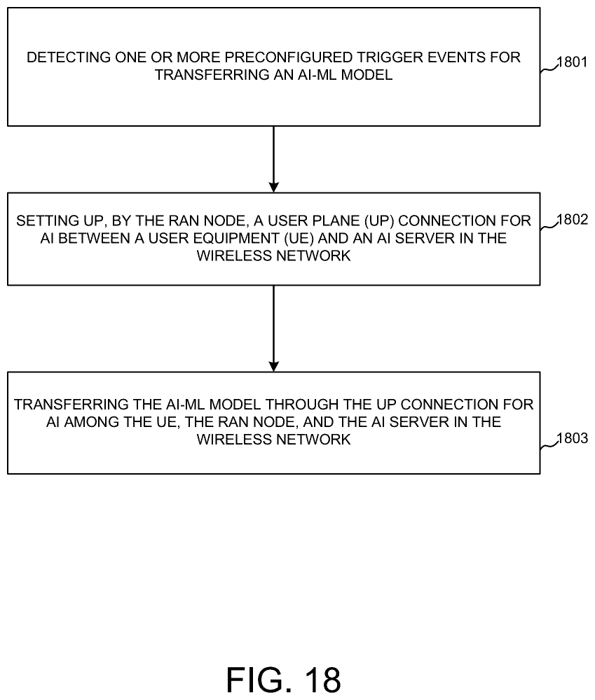

FIG. 18 illustrates an exemplary flow chart for the RAN node to perform the AI-ML model transfer through the UP connection in accordance with embodiments of the current invention. At step 1801, the RAN node detects one or more preconfigured trigger events for transferring an AI-ML model. At step 1802, the RAN node sets up a user plane (UP) connection for AI between a user equipment (UE) and an AI server in the wireless network. At step 1803, the RAN node transfers the AI-ML model through the UP connection for AI among the UE, the RAN node, and the AI server in the wireless network.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for a user equipment (UE) using artificial intelligence-machine learning (AI-ML) model in a wireless network comprising:
detecting, by the UE, one or more preconfigured trigger events for transferring an AI-ML model;
setting up a user plane (UP) connection for AI between the UE and an AI server through a radio access network (RAN) node and a core network (CN) node in the wireless network; and
transferring the AI-ML model with AI-ML model packets through the UP connection for AI in the wireless network.

2. The method of claim 1, wherein the UE downloads the AI-ML model from the AI server, and wherein the AI-ML model is trained and stored at the AI server.

3. The method of claim 1, wherein the UE downloads the AI-ML model from the AI server, and wherein the AI-ML model is trained or updated at the RAN node, and wherein the AI-ML model is transferred from the RAN node to the AI server.

4. The method of claim 1, wherein the AI-ML model is trained or updated at the UE, and wherein the AI-ML model is transferred from the UE to the RAN node through the AI server.

5. The method of claim 4, wherein the UE transfers the AI-ML model to the AI server through the UP connection for AI directly.

6. The method of claim 4, wherein the UE sends upload model request to the RAN node and uploads the AI-ML model to the AI server upon receiving upload model response from the RAN node.

7. The method of claim 1, wherein the one or more preconfigured trigger events comprising a new AI-ML model available at the AI server, an updated AI-ML model at the AI server, a new AI-ML model at the RAN node, an updated AI-ML model at the RAN node, a new AI-ML model at the UE, an updated AI-ML model at the UE, and a UE mobility event.

8. The method of claim 7, wherein the triggering event is a UE mobility event indicating the UE successfully switching from a source RAN node to a target RAN node.

9. The method of claim 8, wherein the UE downloads the AI-ML model from the target RAN node or directly from the AI server.

10. The method of claim 1, wherein the AI-ML model packets includes one or more AI-ML model elements comprising an AI-ML model, and an AI-ML model description.

11. The method of claim 10, wherein the format of AI-ML model is determined based on one or more elements comprising a use case description, an update method, a size of the AI-ML model, and a proprietary setting for the AI-ML model.

12. The method of claim 10, wherein the format of AI-ML model is explicit or implicit.

13. The method of claim 10, wherein the AI-ML model description includes one or more elements comprising a use case description, an indication of delta update, and an indication of implicit or explicit AI-ML model format.

14. A method for a user equipment (UE) using artificial intelligence-machine learning (AI-ML) model in a wireless network comprising:
detecting, by the UE, one or more preconfigured trigger events for transferring an AI-ML dataset;
setting up an AI plane connection to an AI server through a radio access network (RAN) node and a CN node in the wireless network, wherein the AI plane connection enables AI-ML dataset transfer; and
transferring the AI-ML dataset through the AI plane connection in the wireless network.

15. The method of claim 14, wherein the AI plane is a user plane (UP) in the wireless network.

16. The method of claim 14, wherein the AI plane is a new plane established in the wireless network.

17. The method of claim 14, wherein new resource blocks (RBs) are configured for the transfer of the AI-ML dataset through the AI plane in the wireless network.

18. A method for a radio access network (RAN) node in a wireless network comprising:
detecting one or more preconfigured trigger events for transferring an AI-ML model;
setting up, by the RAN node, a user plane (UP) connection for AI between a user equipment (UE) and an AI server in the wireless network; and
transferring the AI-ML model through the UP connection for AI among the UE, the RAN node, and the AI server in the wireless network.

19. The method of claim 18, wherein the AI server is an over-the-top (OTT) server.

20. The method of claim 18, wherein the RAN node transfers the AI-ML model received from the AI server to the UE, and wherein the AI-ML model is trained at the AI server.

21. The method of claim 20, wherein the RAN node parses the AI-ML model before transferring to the UE.

22. The method of claim 18, wherein the AI-ML model is trained or updated at the RAN node, and wherein, the RAN node uploads the AI-ML model to the AI server.

23. The method of claim 18, wherein the AI-ML model is received from the UE through the AI server, wherein the AI-ML model is trained or updated at the UE.

24. The method of claim 23, further comprising: receiving an upload model request from the UE; and sending an upload model response to the UE.

25. The method of claim 23, further comprising: sending a model transfer request to the AI server; and receiving the AI-ML model from the AI server.

26. The method of claim 18, further comprising:
receiving a model transfer request from a target RAN node when the UE switches to the target RNA node; and
transferring the AI-ML model to the target RAN node.

27. The method of claim 18, wherein the transferring of the AI-ML model is triggered upon detecting the UE switches from the RAN node to the target RAN node.

28. A user equipment (UE), comprising:
a transceiver that transmits and receives radio frequency (RF) signal in a wireless network;
a detection module that detects one or more preconfigured trigger events for transferring an AI-ML model;
a setup module that sets up an user plane (UP) connection for AI between the UE and an AI server through a radio access network (RAN) node and a core network (CN) node in the wireless network; and
a transfer module that transfers the AI-ML model with AI-ML model packets through the UP connection for AI in the wireless network.

29. The UE of claim 28, wherein the UE transfers the AI-ML model from the AI server using downlink of the UP connection for AI when the AI-ML model is updated at the AI server or at the RAN node, and the UE transfers the AI-ML model to the AI server using uplink of the UP connection for AI when the AI-ML model is updated at the UE.
